(19) United States
(12) Patent Application Publication
(10) Pub. No.: US 2008/0282734 A1
(43) Pub. Date: Nov. 20, 2008

(54) APPARATUS AND METHOD FOR THE PRODUCTION OF HIGH-MELTING GLASS MATERIALS OR GLASS CERAMIC MATERIALS

(76) Inventors: Uwe Kolberg, Mainz (DE); Thomas Kirsch, Mainz (DE); Paul Kissl, Mainz (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/118,832

(22) Filed: May 12, 2008

(30) Foreign Application Priority Data
May 18, 2007 (DE) 102007023497.1-45

(51) Int. Cl. C03B 5/26; C03B 5/23; C03B 5/235; C03B 5/43

(52) U.S. Cl. 65/32.2; 65/128; 65/32.1; 65/327; 65/157

(57) ABSTRACT

The invention relates to a method and apparatus for the production of high-melting glass materials or high-melting glass ceramic materials by a process during which a temperature of a molten mass exceeds 1,760° C., wherein a shard material or raw material is molten to a molten mass, the molten mass is fined, and the molten mass emerges via a tubular outlet made of iridium or an iridium alloy having an iridium content of at least 50 wt.-%. According to the invention the temperature of a section of said tubular outlet, which is in contact with the ambient atmosphere having a natural gas composition, is controlled or regulated such that said temperature is held below 1,000° C. except during pouring out the molten mass out of said tubular outlet. Thus, an oxidative decomposition of the apparatus can be prevented.

The present application claims priority of German patent application no. 10 2007 023 497.1-45, ‘Method and apparatus for the production of glasses, glass ceramic material or ceramic material’, filed on May 17, 2007, the whole content of which is hereby incorporated by reference. The present application is related to German patent DE 103 48 466 B4, ‘Method and Apparatus for the production of high-melting glasses or glass ceramic material and glass or glass ceramic material’, published on May 31, 2007, German patent DE 103 62 074 B4, ‘High-melting glass or glass ceramic material and use thereof’, published on Dec. 6, 2007 and corresponding U.S. patent application US 2005/0109062 A1, ‘Apparatus and method for the production of high-melting glass materials or glass ceramic materials or glass material or glass ceramic material’, now abandoned. The whole content of the afore-mentioned patents or patent applications is hereby incorporated by reference.

### FIELD OF INVENTION

The present invention relates to a method and apparatus for the production of high-melting glass materials, glass ceramic materials or ceramic materials, in particular of glasses, glass ceramic materials or ceramic materials having a melting point above 1800° C. To be more precise, the invention relates to a method and apparatus for the production of formed members, for example rods, or other solid members, and tubes, or other hollow members, made of high-melting glass materials or glass ceramic materials in a discontinuous operation.

### RELATED ART

Generally, the invention relates to glass materials or glass ceramic materials comprising a very low content of network modifiers, in particular alkali oxides, and glass materials or glass ceramic materials comprising a high content of high-melting oxides, such as, for example, SiO₂, Al₂O₃, ZrO₂, Nb₂O₅ or Ta₂O₅. Glass materials or glass ceramic materials of the aforementioned type have relatively high melting temperatures in the range of approximately 1700° C. To produce these materials, molten glass has to be heated, often for long periods, to relatively high temperatures, for example to refine the molten glass. The relatively high temperatures required in continuous operation place new requirements on the design of crucibles.

A conventional apparatus for the production of tubes and rods in discontinuous operation comprises a crucible serving as a melting vessel that is usually made from Pt and Pt alloys, for example PtRh30. A tube comprising one of the aforementioned noble metals is welded-on under the crucible with said tube being heated by one or more heating circuits that are independent of the crucible heating. This ensures that the temperature setting for the tube decisive for the hot forming process can be independent of the temperature setting of the crucible.

This arrangement has proved its worth in numerous instances. However, it does has the drawback that the maximum temperature is restricted to approximately 1760° C. and the service life of the apparatus at temperatures as high as this is greatly restricted. However, glass materials or glass ceramic materials that only comprise a very small content of network modifiers, in particular alkali oxides, or glass materials or glass ceramic materials comprising a high content of high-melting oxides such as, for example, Al₂O₃, SiO₂, ZrO₂, Nb₂O₅ or Ta₂O₅ require higher melting temperatures under some circumstances or have to be more sintered than melted at the maximum possible temperatures for uneconomically long processing periods.

EP 1 160 208 A2 discloses a crucible for the continuous production of glass formed members. The crucible is produced from a metal that is able to withstand the melting point of the glass, namely molybdenum or tungsten. To prevent oxides in the wall of the crucible from diffusing into the molten glass where they can cause discoloration of the glass and result in occlusions in the glass, the wall of the crucible is lined with a layer of a low-reactivity metal that only melts at a high temperature. The lining comprises rhenium, osmium, iridium or alloys of these metals.

The double wall structure of the crucible is comparatively expensive and necessitates a relatively complex structure that must be capable of permitting the establishment of a hydrogen-containing protective gas atmosphere in the internal and external areas of the crucible in order to suppress the combustion of the molybdenum or tungsten at the high temperatures used. However, this hydrogen-containing gas creates various problems: firstly, it is combustible and requires expensive safety systems, secondly the construction materials may be subject to embrittlement and thirdly, and this is of extreme importance with regard to the molten glass, the hydrogen-containing gas prevents the use of glass components with different oxidation stages and easily reducible components. For example, the normal redox fining agents AS₂O₃, Sb₂O₃ and SnO₂ cannot be used, but the fining must be performed with expensive helium and this is relatively inefficient.

This apparatus requires a system of channels to feed the mixture and it is not possible to use a drawing tube with a die for the forming, such as is unavoidable for establishing the viscosity of the glass for precision shaping. This means that, although this apparatus is suitable for ultra-pure silica glass for which no fining agents (=contaminants). Therefore, this apparatus is generally too complex and too expensive for the economical and simple production of high-precision glass parts in a discontinuous operation.

U.S. Pat. No. 6,482,758 B1 discloses the use of a crucible made of Iridium (Ir) for the production of high-melting, crystallising glass materials. However, here, the crucible is removed from the heating unit after the fining and tipped out. It is self-evident that this procedure is only suitable for relatively small crucibles, for example for laboratory-scale experiments, because, due to their weight, large crucibles are not easy to remove manually or if lifting devices are used would deform under their own weight unless they had unaffordable wall thicknesses. In addition, this apparatus cannot be used for complex or defined forming processes, such as tube drawing, but only for casting in a block-shaped compact mould. A further drawback occurs with glass materials with a tendency to crystallise in that with casting over the edge, uncontrolled temperature profiles and/or evaporation products on the upper edge can trigger the unwanted crystallisation.

Also known from prior art are crucibles made of iridium or an alloy with a high iridium content. Crucibles of this kind are used in crystal growing, for example for crystal growing using the known Czochralski process. In such cases, starting materials are again melted at high temperatures. However, crystals are a completely different class of substance with completely other processing properties. For example, the known fining process and the addition of a fining agent are omitted during crystal growth. The forming is also quite different because the shape of a grown crystal is determined by the seed crystal and the forming of the generally very complex drawing device. Crystal drawing devices cannot, therefore, be used to produce glass materials. Since crystals solidify suddenly at a defined temperature, hot forming processes involving a tube system and temperature reduction with a subsequent increase in viscosity over several hundred degrees are in principle not possible either.

U.S. Pat. No. 4,938,198 discloses an apparatus and a method for the production of greatly reducing phosphate glass materials with a vessel for accommodating molten glass and with a container that accommodates the vessel whereby the vessel comprises a tubular outlet, the vessel and the tubular outlet comprise oxygen-permeable platinum or an oxygen-permeable platinum alloy and whereby the container is designed to accommodate the vessel and the tubular outlet under an oxygen atmosphere.

U.S. Pat. No. 4,938,198 also refers to the fact that the vessel for accommodating the melt should not be made of iridium or an iridium alloy since the processing of iridium to produce a vessel is relatively difficult and the external surface of the vessel has to be coated with an inert metal, such as rhodium, which is expensive.

JP 02-022132 A discloses an apparatus for the production of molten glass in the temperature range 1000° C. to 2000° C. It also discloses the fact that iridium is in principle suitable as a high-temperature material in order to prevent the corrosion, caused by the presence of melts at high temperatures, of the vessel for accommodating the molten glass. However, no specific measures regarding the heating, the choice of refractory material, the hot forming, the type of glass used, the system control or the stabilisation of the iridium or the iridium alloy are disclosed.

FIG. 2 is a schematic partial section of a crucible 102 serving as a vessel for accommodating molten glass with a tubular outlet 104 according to the German patent DE 103 48 466 B4, corresponding to US 2005/0109062 A1, the entire content of which is hereby incorporated by reference. In its upper part, the crucible 102 has a crucible wall 106 produced from a sheet that has been suitably cut to size and positively connected along the weld seam 108 by welding. Suitable notches in the sheet ensure that the base 109 is suitably shaped and connected to the rest of crucible wall 106 by means of a weld seam that is not shown.

The outlet tube 104 serving as a tubular outlet, which comprises several segments 110 to 114, starts in the middle of the base 109. In the example shown, the outlet tube 104 has a round cross section. The outlet tube 104 can also have a different cross section. The individual segments 110 to 114 are each produced from one sheet that is suitably cut to size and connected along the relevant weld seam 116 to a tubular body. The upper segment 110 has a conical segment and is connected to the base 109 of the crucible 102. The conical shape encourages the running out of the molten glass from the cylindrical part of the crucible 102 into the outlet tube 104. The other segments 111 to 114 are substantially straight. In the upper part A of the outlet tube 104, the segments 110 to 113 are made of iridium or a material with a high iridium content, as explained in the following. In the lower part B of the outlet tube 104, the segment 114 or the several segments (not shown) comprise an oxidation-resistant alloy, preferably PtRh30 or PtRh20.

At the lower end of the outlet tube 104, there is a draw die 115 that serves as a hot forming device in order to shape the molten glass emerging from the outlet tube 104 to produce a formed part. The outlet tube 104 is resistance-heated by means of an electrical current that flows through the wall of the segments 110 to 114.

The conical segment 110 is connected to the base 109 of the crucible 102 by means of a weld seam. The other segments 111 to 113 made of iridium or the material with a high iridium content are also preferably connected to each other by means of welded joints. The melting temperatures of iridium or an alloy with a high iridium content, which comprises at least 50 wt.-% iridium, and other oxidation resistant alloys, which are used to form the segment 114 of the section B of the outlet tube 104 differ greatly. Therefore, the segment 114 made of the low-melting oxidation-resistant alloy cannot be connected to the segment 113 made of iridium or the alloy with a high iridium content by means of a welded joint. The joint is formed by a sort of plug coupling in which the segment 113 is pushed into the segment 114 with a tight fit. At the high operating temperatures a kind of “overmelting” of the various materials occurs, which causes an adhesive bonding of the various different materials. The external diameter of the segment 113 and the internal diameter of the segment 114 are matched to each other in such a manner that when the plug connection is formed, a sort of bead comprising the material of the low-melting oxidation-resistant alloy of segment 114 is located around the material of segment 113 which serves to seal the outlet tube 104 in the transitional area 139 between section A and section B.

FIG. 1 shows a schematic cross section of an apparatus for the production of high-melting glass materials or high-melting glass ceramic materials in a discontinuous operation in accordance with German patent DE 103 48 466 B4, corresponding to US 2005/0109062 A1 of the applicant. The apparatus 101 comprises the crucible 102 according to FIG. 2, which is accommodated in a container comprising a lower container section 119 and an upper container section 120. The crucible 102 is accommodated in the container in such a way that the upper edge of the crucible 102 does not protrude above the upper edge of the upper container section 120. The upper container section 120 is covered by a cover 121. Overall, the container with this design is adequately sealed from the ambient atmosphere so that a protective gas atmosphere may be established in the interior of the container where the crucible 102 is accommodated in order to prevent unwanted oxidation formation on the iridium or the material with a high iridium content of the crucible 102 and of section A of the outlet tube 104 (see FIG. 2).

Arranged around the crucible 102, is a water-cooled induction coil 103 that extends in a spiral and with a non-vanishing pitch around the crucible 102. The induction coil 103 is arranged at a slight distance to the external wall of the crucible 102, preferably a distance of approximately 60 to 80 mm. Between the induction coil 103 and the crucible 102, there is a refractory cylinder 123 radially surrounding the crucible 102 which is sealed at the bottom by the second base element 126 and the first base element 125. The space formed in this way between the surface of the internal circumference of the refractory cylinder 123 and the surface of the external circumference of the crucible 102 is filled with MgO pellets 124 in order to ensure that the crucible 102 is sufficiently dimensionally stable even at temperatures of approximately 2000° C. The pellets in the pellet filling 124 must be sufficiently thermally and dimensionally stable and oxidation-resistant at the specified temperatures. Therefore, MgO should preferably be used as the material for the pellet filling, but the invention is not restricted to this. The use of ZrO₂ is also feasible, for example. The pellets in the pellet filling 124 may also have a superficial shape deviating from the circular. Overall, however, a sufficient gas flow, in particular protective gas flow, will be maintained in the space between the surface of the internal circumference of the cylinder 123 and the surface of the external circumference of the crucible 102, so that an inert protective gas flows around the crucible 102 in order to prevent undesired oxide formation of the iridium or the material with a high iridium content, which consists of at least 50 wt.-% iridium, in the crucible 102.

A sufficient gas flow may be ensured in the aforementioned space if the pellets in the pellet filling 124 have a diameter of at least approximately 2.0 mm, more preferably at least approximately 2.5 mm and even more preferably at least approximately 3.0 mm.

Operation of the apparatus according to FIGS. 1 and 2 revealed, however, that after a certain operation period, e.g. after two or three months, a failure of the outlet tube occurred, in particular leakages in the peripheral wall thereof, which resulted in an undesirable, uncontrollable leakage of molten glass to the side thereof.

### SUMMARY OF INVENTION

It is the object of the invention to provide a method and apparatus with which high-melting glass materials or high-melting glass ceramic materials may be produced even more reliably and in a suitable quality.

Thus, the present invention proceeds with a method for the production of high-melting glasses or glass ceramic materials according to German patent DE 103 48 466 B4, corresponding to US 2005/0109062 A1, wherein a vessel for accommodating molten glass is used, which comprises a tubular outlet, the vessel is disposed within a container, the vessel and the entire tubular outlet if formed of iridium or an iridium alloy consisting of at least 50 wt.-% iridium, and a protective atmosphere are formed within the container in such a manner, that the vessel and a portion of the tubular outlet are received in the container under the protective atmosphere, which prevents oxidation of the iridium or of the iridium alloy which comprises at least 50 wt. % iridium. Therein, a front free end of the tubular outlet passes an opening disposed in a bottom of the container towards the ambient atmosphere. According to the present invention, the temperature of the front free end of the tubular outlet, which is outside the container, is controlled or regulated in such a manner that this portion is always held at temperatures below about 1,000° C., preferably below about 950° C., with the exception of a stage during which the molten glass runs out of the tubular outlet.

According to such a process control or regulation the afore-mentioned failure of the tubular outlet can be prevented reliably even over extended operating periods, which substantially exceed a time period of two to three months. Experiments of the inventor have revealed that in the apparatus according to DE 103 48 466 B4 a cause for the failure of the tubular outlet is always the joining between the portion of the tubular outlet consisting of iridium or of the iridium alloy containing at least 50 wt.-% iridium with the portion produced of the oxidation-resistant alloy, e.g. PtRh20. Furthermore, by means of elaborate metallographic testing the inventors have found out that elements of the platinum group of the portion produced of the oxidation-resistant alloy, in particular Pt. or Rh, diffuse into the portion produced of iridium or of the iridium alloy consisting of at least 50 wt.-% iridium leaving a void in this material. These voids accumulate over the time so that pores are formed within the material of the tubular outlet. As soon as the total number of pores exceeds a certain range, the joining between the two portions of the tubular outlet produced of the different materials did not exhibit anymore a sufficient rigidity or strength so that the joining finally broke under mechanical loads. A further cause for the above failure can be local peaks of the heating current due to material inhomogeneities in the tubular outlet, which results in local melting of the residual material. As according to the present invention the entire tubular outlet is formed of iridium or of the iridium alloy consisting of at least 50 wt.-% iridium, this weak point of the tubular outlet is eliminated according to the present invention. Namely, the diffusion of alloy constituents cannot occur anymore, because the driving thermodynamic force does not exist anymore.

As can be concluded from the above prior art, parts of the crucible or tubular outlet, which are exposed to the oxidative ambient atmosphere, decompose rapidly under evaporation of gaseous iridium oxide. For that reason, according to the prior art a setup was used, wherein the crucible and a first portion of the tubular outlet were received within a container under a protective atmosphere and wherein the front free end of the tubular outlet, which was exposed to the ambient atmosphere, was produced of a material other than iridium or the iridium alloy, which consists of at least 50 wt.-% iridium, namely of an oxidation-resistant alloy from the platinum group. Elaborate experiments of the inventor, however, showed that even a suitable process control and optional further measures cannot reliably prevent the oxidative decomposition of the iridium or of the iridium alloy consisting of at least 50 wt.-% iridium forming the front free end of the tubular outlet exposed to the ambient atmosphere.

As a first measure for preventing the afore-mentioned oxidative decomposition according to the present invention a suitable temperature control is used. This measure is based on the surprising finding that the front free end of the tubular outlet, which is exposed to the ambient atmosphere, can be held at a sufficiently low temperature, at least during a discontinuous operation of the apparatus, over the major part of time so that the afore-mentioned oxidative decomposition substantially does not occur. As regards the oxidation characteristics of elements of the platinum group, reference is made e.g. to J. C. Chaston, ‘Reactions of oxygen with the platinum metals’, Platinum metals review 1965, vol. 9 (2), pages 51-56. It turned out that a fresh or untreated surface of iridium or of a high iridium content is covered by a very thin layer of an oxide upon heating, which probably acts as a barrier for preventing a further growth of the oxide layer. Upon further heating to temperatures above approx. 400° C. the start of growth of the oxide layer can be observed. Nevertheless, this oxide layer serves as a protection against an uncontrolled oxidative decomposition. Surprisingly it turned out that at least with the restricted geometry, which exists at the front free end of the tubular outlet, with restricted exchange with the ambient atmosphere, these oxide layers on the outer surface of the front free end of the tubular outlet, which is exposed to the ambient atmosphere, sufficiently prevent the afore-mentioned oxidative decomposition of the tubular outlet at temperatures up to 1,000° C. As regards the process control according to the present invention, care must be taken, however, that the total time period over which the front free end of the tubular outlet, which is exposed to the ambient atmosphere, is at a high temperature, is minimized.

According to a further embodiment the temperature control is such that the front free end of the tubular outlet, which is exposed to ambient atmosphere, is always held at a temperature below about 950° C., i.e. well below the afore-mentioned limit temperature of 1,000° C. with the exception of that stage of the process, during which the molten glass pours or runs out of the tubular outlet, in order to prevent the afore-mentioned oxidative decomposition to a sufficient extent.

As a further measure for preventing the afore-mentioned oxidative decomposition according to a further embodiment the inner part of the front free end of the tubular outlet is protected against the influences of the ambient atmosphere by means of a plug or stopper of glass material. Surprisingly, extensive experiments of the inventor have shown that glass material is well suited for protecting the inner part of the front free end of the tubular outlet against the influence of the ambient atmosphere to a sufficient extent so that the front free end can be produced of iridium or of the iridium alloy, consisting of at least 50 wt.-% iridium. Conveniently, to this end that glass is used that is already to be molten in the crucible, which depends in particular on the softening temperature of the glass type used. For formation of a suitable glass plug the orifice of the tubular outlet is closed by means of a closure member, which is preferably cooled and formed of a metal, such as copper, and are shards, preferably of the same composition as the glass to be produced or of a different composition, in cold condition placed in the tubular outlet afterwards. Afterwards, the tubular outlet is heated beyond the softening temperature of the shard material or raw material placed into the tubular outlet. As the orifice of the tubular outlet is closed by the closure member, the inserted shard material or raw material cannot rinse out of the tubular outlet during the stage of inserting and heating. During the stage of heating the afore-mentioned limit temperature of about 1,000° C., preferably of about 950° C., where the deterioration of the iridium or of the iridium alloy, which consists of at least 50 wt.-% iridium, starts is not exceeded. In the lower part of the tubular outlet a compact plug of molten, gastight glass is formed, which abuts to the material of the tubular outlet without cracks or gaps and is in close contact to the closure member, which is preferably cooled. In this manner according to the present invention the inner part of the front free end of the tubular outlet is sealed against the ambient atmosphere.

According to a further embodiment the afore-mentioned steps of placing in or inserting the shard material or raw material, of heating the tubular outlet beyond the softening temperature of the shard material or raw material and of cooling the tubular outlet until formation of a plug can be repeated as often as necessary until the entire tubular outlet, i.e. up to the transition area towards the crucible, is sealed by a plug. Therein, that portion of the crucible and of the tubular outlet, which are disposed within the container, are protected against ambient atmosphere in the manner, as described in German patent DE 103 48 466 B4, corresponding to US 2005/01909062 A1. Therein, according to a further embodiment the crucible itself needs not to be heated at all, if the crucible and the tubular outlet can be heated by means of separate heating means.

As the shard material, which is placed or inserted into the tubular outlet, is in the form of glass shards, no gas is released during melting of the glass raw material, which would otherwise cause an undesired oxidation of the inner surface of the tubular outlet or of the crucible. Preferably, for the formation of the afore-mentioned glass plug a temperature control with steep temperature ramps is used so that the temperature of the tubular outlet can be raised rapidly to temperatures above the softening temperature and can be lowered rapidly afterwards again. To this end it is preferred, if the front free end of the tubular outlet is actively cooled, which can be assisted further by means of an additional cooling means in the vicinity of the front free end of the tubular outlet, which is exposed to ambient atmosphere. According to a further embodiment, however, the closure member is actively cooled and is formed of a metal so that by means of a tight contact of the closure member with the material of the tubular outlet an adequate thermal contact can be ensured for rapidly dissipating heat from the front free end.

In particular in the case, if the softening temperature of the glass to be produced is above 1,000° C., for formation of the afore-mentioned plug within the tubular outlet also different shards of any other non-oxidative glass can be used. In such an embodiment the steps of placing in or inserting of the shard material of a different composition as the glass to be produced into the tubular outlet, of heating the tubular outlet above the softening temperature of the shard material placed into the tubular outlet and of cooling the tubular outlet for formation of the plug are repeated as often as necessary until a glass plug is formed within the tubular outlet, which seals the tubular outlet in a gas-tight manner.

According to a further embodiment, in which a different type of glass is used for formation of the glass plug, the mixing of the content of the tubular outlet with the content of the crucible is prevented by controlling the temperature within the tubular outlet to be at least 100° C. cooler as the temperature within the crucible during the stage where no flow occurs in the apparatus, i.e. in the stage when the tubular outlet is closed by the closure member, which can be easily accomplished in particular by means of separate heating means for the crucible and for the tubular outlet. When the molten glass runs or pours out, in such an embodiment the first part of the cast is initially discarded and only then, when the entire content of the tubular outlet has been poured out, the molten glass is used for the production of a formed body of glass or a glass ceramic material. Because the volume of the tubular outlet is, however, small in comparison to that of the crucible, this is economically possible. After the first cast the tubular outlet is filled with the glass to be produced for all subsequent cycles until the glass type is changed or the configuration of the apparatus is to be modified.

During all stages with the exception of the casting stage (discontinuous operation) the front free end of the tubular outlet, which is outside the container, can be protected by dissipating as much heat of the actively cooled closure member, which is made e.g. of copper, that the temperature remains below the afore-mentioned 1,000° C., preferably below 950° C., which temperature is critical for the afore-mentioned oxidative decomposition.

As will be apparent to a person skilled in the art, the inner surface of the front free end of the tubular outlet, which is outside the container, is protected by the glass pouring out also during the stage of casting or during the discontinuous operation, even if the temperature then is above 1,000° C., which depends on the characteristics of the glass type. Therefore, in a further embodiment, during the stage of casting or pouring out the molten glass out of the tubular outlet, further measures are necessary in order to protect the outer surface of the front free end of the tubular outlet, which is outside the container, against an uncontrolled oxidative decomposition.

According to a further embodiment, this is accomplished by blowing an inert protective gas onto the outer surface of the front free end of the tubular outlet, which is outside the container. Therein, one should take into account that due to the limited and upwards closed geometry in the vicinity of the orifice of the tubular outlet only a limited gas exchange occurs with the oxygen-containing ambient atmosphere, because the front free end of the tubular outlet is disposed within a cylindrical cavity, which is closed at the upper end thereof. If this cavity is flushed with a sufficient amount of an inert protective gas, the afore-mentioned oxidative decomposition of the front free end of the tubular outlet can reliably be prevented.

According to a further embodiment, a perforated or porous, cylindrical or annular member is put over the front free end of the tubular outlet outside the container, which directs the inert protective gas over the outer surface of the tubular outlet. Preferably, this perforated or porous member is formed of a metal, which effectively assists in particular the temperature management and an active cooling of the front free end. As an alternative, also a ceramic or metallic sintered member can be used.

According to a further embodiment, the porous member is a sintered member of a metal or of a metal foam. The perforated or porous member can be cooled actively, e.g. by means of a coolant flowing there-through. To this end, also the inert protective gas can flow through the perforated or porous member in a cooled state and in the liquid and/or gas phase.

According to a further embodiment, the inert protective gas comprises N2 and/or a noble gas or consists of both of these gases. According to a further embodiment, H2 can be mixed to the inert protective gas, so that harmful oxygen is not only squeezed out but also removed by means of a chemical reaction, namely by oxidization of hydrogen.

Additionally or as an alternative to the afore-mentioned screening of the outer side of the tubular outlet, the outer surface of the front free end, which is outside the container, can also be lined by a gas-tight, thin layer of a refractory, ceramic material, in particular as an additional safety measure for the case of a breakdown of the protective gas atmosphere or for reducing the evaporation of crucible material. This refractory, ceramic material can by applied in particular using plasma-spraying. For further details concerning such a lining of a refractory, ceramic material, reference is made to WO 02/44 115 A2 of the applicant, which corresponds to US 2004/0067369 A1, the entire content of which is hereby incorporated by reference. Such refractory, ceramic materials may consist in particular of ZrO₂, Y₂O₃, MgO or mixtures of these materials. To this end, the layer is formed sufficiently thick so that it is gas-tight but does not result in flaking due to the prevailing temperature changes.

High-melting glass materials or high-melting glass ceramic materials within the meaning of this application should be understood to mean in particular glass materials or glass ceramic materials that are produced in a process during which the temperatures exceed the normal maximum temperature of 1760° C. determined by the platinum-containing material of the conventional crucible. This does not exclude the possibility that the melting point of the molten glass could itself be below 1760° C. As will be described in more detail below, according to the invention, however, temperatures of approximately 2000° C. or even up to approximately 2200° C. may be achieved. Since, according to the invention, higher temperatures may be achieved for melting and fining the molten glass, it is possible to obtain high-melting glass materials or glass ceramic materials of this type with surprisingly advantageous properties, in particular with regard to optical transmission, thermal expansion and for the use as transitional glass materials to connect two types of glass material with different coefficients of thermal expansion.

A further use resided in the use for coating glasses or evaporation glasses in vacuum devices. To this end it is necessary that the molten glass does not contain alkali oxides so that exceptionally high temperatures can be achieved so that the molten glass does not contain any bubbles, which requires an excellent fining, in particular at high temperatures, and so that the molten glass does not contain any dissolved gases that could cause foaming under vacuum conditions, which also requires an excellent fining, in particular at high temperatures.

The inventors discovered that the aforementioned relatively high temperatures may easily be achieved when using iridium or a an iridium alloy containing at least 50 wt.-% iridium. Iridium itself is known to have a melting point of approximately 2,410° C. to approximately 2,443° C. and alloys with a high iridium content have an only slightly lower melting point. Even if this means that, according to the invention, processing temperatures of up to approximately 2,400° C. are in principle feasible, according to the invention, for safety reasons, a temperature interval of approximately 100° C. to approximately 200° C. from this upper limit should be adhered to, for example to avoid local overheating, inadequate temperature measurements or reduced stability due to the iridium's grain boundary growth. Extensive test series performed by the inventors revealed that even at the aforementioned high temperatures, iridium itself only reacts to a relatively low degree with the molten glass.

According to the invention, oxide formation of the iridium or iridium alloy containing at least 50 wt.-% iridium at high temperature in the presence of oxygen may be prevented in a surprisingly simple way by designing the container in such a manner that the iridium or iridium alloy, which consists of at least 50 wt.-% iridium, of the apparatus, in particular of the vessel and of the first section of the tubular outlet, is accommodated under a protective gas atmosphere. An advantageous feature is that this achieves an apparatus that is stable over a long time period. As regards further details of the configuration, operation and design of the container and apparatus reference is made to German patent DE 103 48 466 B4 of the applicant, which corresponds to US 2005/0109062 A1, the entire content of which is hereby incorporated by reference.

According to another preferred embodiment, the iridium forming the crucible and the tubular outlet comprises an iridium content of at least approximately 99%, more preferably at least approximately 99.5% and even more preferably at least approximately 99.8%. Quite particularly preferably, the noble metal content of the iridium is at least 99.95%. Other elements of the platinum group could be mixed with the iridium, preferably in concentrations of less than approximately 1000 ppm. In principle, also suitable as a iridium alloy is a platinum group metal alloy with an iridium content of at least approximately 95%, more preferably at least approximately 96.5% and even more preferably at least approximately 98%. The aforementioned materials may easily be produced in sheet form and shaped into the vessel or tubular outlet in the desired design. Even thin-walled profiles still have adequate dimensional stability at the aforementioned relatively high temperatures.

According to a further embodiment, the vessel and tubular outlet are heated by means of at least two heating devices that may be controlled or regulated independently of each other. This means that it may be guaranteed that the actual vessel is maintained at the aforementioned relatively high temperatures, for example for the fining of the molten glass, while the tubular outlet or at least its front free end may be maintained at a temperature below the softening temperature of the glass plug. In addition, it is possible to establish a suitable temperature profile in the apparatus during the heat forming of the molten glass, for example even slightly different temperatures in the vessel and in the tubular outlet.

The tubular outlet may be heated by an external heating device, for example by an external induction coil surrounding the outlet. Preferably, the tubular outlet is heated electrically by means of resistance heating. Quite particularly preferably, the heating current is applied directly to the wall of the tubular outlet.

According to a further embodiment, the vessel to accommodate the molten glass is covered by a cover providing thermal insulation for the molten glass and/or further protection for the molten glass against the ambient atmosphere. The cover may comprise a ceramic material. Preferably, the cover has a lid that may be opened on the melting down of the molten glass raw material for the introduction of more raw material, for example by pivoting or displacing. Preferably, the lid comprises an oxidation-resistant alloy, preferably a PtRh20 alloy that may be obtained for little cost and is sufficiently dimensionally stable and low-reactive. However, it is also possible to use Ir or Ir alloys as lids. In this case, as with the oxidation protection for the outlet tube, here it is possible to use a combination with an oxidation-resistant noble metal or a noble metal alloy and with iridium or an alloy containing at least 50 wt.-% iridium for the lid, whereby the iridium or the iridium alloy is arranged inside the container with the protective gas atmosphere and the oxidation-resistant noble metal or the noble metal alloy may also be arranged outside the container with the protective gas atmosphere. Preferably, a Pt/Rh20 alloy is used as a noble metal alloy in this embodiment.

In a further embodiment, the vessel and the cover may be pressure-tight. To this end, the upper edge of the vessel and an inner circumference of the cover may be ground smooth and a sealing means, for example a metal ring, may be provided on the upper edge of the vessel. With this embodiment, the vessel has a gas inlet so that a gas under overpressure may be introduced into the interior of the vessel in order further to encourage the emergence of the molten glass out the tubular outlet. The overpressure in the vessel may, for example, also compensate the decreasing hydrostatic pressure on the emergence of the molten glass from the vessel. For the control or regulation of the overpressure in the vessel, it is possible to provide a control or regulating device that receives a signal from a pressure sensor provided in the vessel or in the cover.

For establishing a certain overpressure in the vessel preferably an inert gas is used. Particularly preferably, this inert gas has the same composition as the gas used to establish a protective gas atmosphere in the container.

According to a further embodiment, at least temporarily, an inert protective gas is supplied to the container for the establishment of an adequate protective gas atmosphere. To this end, the container comprises a gas inlet with which to feed an inert protective gas into the interior of the container connecting the container with a gas reservoir. Preferably, the inert protective gas is designed to maintain neutral to slightly oxidising conditions in the interior of the container.

Particularly suitable as the protective gas are argon or nitrogen, which are simple to handle and cheap to obtain. The inventors have found in extensive test series that mixtures with an oxygen content of between approximately 5×10⁻³% and approximately 5% and more preferably between approximately 0.5% and approximately 2% are advantageous because these can prevent reactions between the material used for the vessel and the glass components, in particular the reduction of glass components with subsequent alloy formation. Compared to conventional crucibles, in which primarily tungsten or molybdenum is used as a substrate for an internal lining in the crucible, according to the invention it is possible to completely dispense with the use of a hydrogen-containing protective gas resulting in a simplification of the structure and a broader range of applications with regard to the glass composition. In addition, according to the invention, the normal redox fining agents, such as for example As₂O₃, Sb₂O₃, SnO₂ may be used. In principle, it is also possible to dispense with the use of expensive He to reduce bubble formation during the fining of the molten glass.

To establish the protective gas atmosphere, the protective gas may be passed continuously through the container. Preferably, the container has a cover that serves not only to provide thermal insulation for the vessel arranged in the container but also to retain a certain amount of the protective gas in the interior of the container. In this way, an equilibrium of flow of the protective gas atmosphere can be guaranteed with a low protective gas flow rate.

According to a further embodiment, the container may be designed to be pressure-tight so that it is possibly completely to suppress any exchange of the protective gas in the interior of the container. In order to establish an overpressure, a pressure-relief valve may be provided in the container. In addition, a gas outlet may be provided to discharge the inert protective gas from the interior of the container.

According to a further embodiment, the vessel is heated by an induction coil wound around the vessel. The basic shape of the induction coil is preferably adapted to match the basic shape of the vessel, whereby the vessel is preferably arranged in a centrosymmetrical manner within the induction coil. The induction coil is arranged at a suitable, short distance from the vessel and preferably extends over the entire height of the vessel. Preferably, the induction coil is wound in a spiral with a pitch different from 0° because this permits the achievement of more homogeneous temperature profiles. However, the induction coil may also be wound around the vessel in a wave-shape, divided when viewed from the side into rectangular segments, with a pitch of the individual segments of the induction coil of substantially 0°. Preferably, the induction coil is water-cooled.

According to a further embodiment, a heat-resistant jacket is provided between the side wall of the vessel and the induction coil, preferably with the same basic shape as the vessel. If the vessel has a circular cross section, the jacket is designed as a cylinder. The material used for the cylinder or the jacket should be able to withstand the prevailing ambient temperature around the vessel. Preferred, therefore, are materials that are also still adequately dimensionally stable at temperature of approximately 1,750° C., for example a ceramic fibre protective sheath made of ZrO₂ or Al₂O₃ fibres. The use of fibre materials is advantageous because they have a lower thermal conductivity than solid ceramic materials. However, it is also possible to use ceramic materials with an adequate stability and insulating effect at 1,750° C., for example sillimanite.

According to a further embodiment, a filling of heat-resistant pellets is provided between the side wall of the vessel and the jacket or the cylinder. The pellets do not necessarily have to be spherical, but could also have, for example, an elliptical shape or an irregular shape. The filling lying on the outer wall of the vessel and on the internal wall of the cylinder or the jacket effects a homogenisation of the pressures and the absorption of the mechanical stresses around the vessel. Therefore, the filling counteracts any deformation of the vessel, due, for example, to the softening of the side walls of the vessel. Overall, therefore, even at the very high temperatures of up to approximately 2,000° C., preferably 2,200° C., according to the invention, it is possible to achieve adequate dimensional stability of the vessel used for the melting and fining of the glass. They also ensure an adequate insulating effect to enable the aforementioned materials to be used as a heat-resistant jacket.

According to a further embodiment, the inert gas used to establish the protective gas atmosphere also passes through the filling of pellets in order to prevent oxide formation on the vessel. Extensive test series performed by the inventors found that an adequate gas through-flow may be achieved if the pellets in the pellet filling have a diameter of at least approximately 2.0 mm, more preferably at least approximately 2.5 mm and even more preferably at least approximately 3.0 mm. In principle, however, an adequate gas through-flow may also be achieved by an irregular surface shape of the pellets right up to a basic shape tending towards the cuboidal. Preferably, the pellets in the pellet filling comprise magnesium oxide (MgO) because this material is sufficiently heat and oxidation-resistant and dimensionally stable. The use of ZrO₂ is also possible.

According to a further embodiment, as an alternative a layer of MgO-bricks or stones is disposed between the side wall of the vessel and the jacket or the cylinder. Thus, a sintering or slumping down of the pellet filling can be prevented. Thus, a complete enclosure of the crucible is ensured, so that the thermal insulation can be reliably maintained even during an extended operation time period. Further, bores for thermo-elements and the like to be inserted subsequently can be formed in the dimensionally stable MgO bricks or stones, which significantly reduces efforts for measuring the temperature.

According to a further aspect of the invention, an apparatus for the production of high-melting glass materials or glass ceramic materials is provided as set forth above.

Preferably, such an apparatus is operated in two different operating modes in sequence. In a first operating mode, the mixture is introduced into the vessel for melting down. The temperature of the vessel is then increased to the above-mentioned relatively high temperatures at which the molten glass is refined in the known way. These temperatures are way above the subsequent processing temperature chosen for the molten glass. In the first operating mode, the tubular outlet is preferably maintained at a much lower temperature at which the molten glass solidifies or hardens in order to form a plug or stopper that blocks the tubular outlet and prevents the molten glass from running out. In order to achieve an even more homogeneous end product, therefore, the first part of the molten glass emerging during the later hot forming may be separated off. During the fining, the heating of the tubular outlet may be switched off or suitably controlled or regulated to compensate heat losses.

In a subsequent, second operating mode, following the fining, the temperature of the molten glass is reduced to the actual processing temperature and the tubular outlet is heated to the processing temperature. In the second operating mode, the vessel and the tubular outlet may be kept at the same temperature or at different temperatures.

According to the invention, during the first operating mode, temperatures of at least approximately 1,800° C., preferably of at least approximately 2,000° C. and even more preferably of at least approximately 2,200° C. may be achieved. In principle, any glass compositions may be treated at these temperatures.

Particularly preferably, according to the invention glass compositions are used that comprise approximately 80 wt.-% (i.e. % by weight) to approximately 90 wt.-% SiO₂, approximately 0 wt.-% to approximately 10 wt.-% Al₂O₃, approximately 0 wt.-% to approximately 15 wt.-% B₂O₃ and less than approximately 3 wt.-% R₂₀ whereby the content of Al₂O₃ and B₂O₃-together is approximately 7 wt.-% to approximately 20 wt.-% and R stands for an alkali element from a group comprising Li, Na, K, Rb and Cs. As will be described in more detail in the following, transitional glass materials with even more advantageous properties may be achieved in this way, in particular with regard to their optical transmission, their thermal expansion and their homogeneity. In addition, cordierite glasses with even more advantageous properties may be produced.

Expediently, the glass composition may additionally contain further high-melting oxides, for example, up to approximately 20 wt.-% MgO and/or up to approximately 10 wt.-%, more preferably up to approximately 5 wt.-% of TiO₂, ZrO₂, Nb₂O₅, Ta₂O₅, WO₃ or MoO₃ or mixtures thereof.

According to a further embodiment a part of the SiO₂, namely up to approximately 50% of the SiO₂, may be substituted by GeO₂ and/or P₂O₅.

It has been found to be particularly advantageous if the molten glass in the vessel is stirred during the first operating mode or during the fining by means of a stirring device made of iridium or an iridium alloy having an iridium content of at least 50 wt.-%, with the above-described properties. The stirring device may be connected to a gas reservoir in order to blow in a gas to reduce the molten glass. In addition, this may also additionally homogenise the melt. Other effects include the acceleration of the melting and fining. Blowing in a gas can also achieve the drying of the glass or a reduction of the OH (water absorption band) in the NIR (near infrared region). This may also reduce the residual gas content in the glass, which may be advantageous for subsequent hot reprocessing. A further preferred use of the glass according to the present invention is the use as a coating or evaporation class.

According to a further aspect of the invention, that may also be claimed independently, a high-melting glass material or a high-melting glass ceramic material is provided comprising approximately 80 wt.-% to approximately 90 wt.-% SiO₂, approximately 0 wt.-% to approximately 10 wt.-% Al₂O₃, approximately 0 wt.-% to approximately 15 wt.-% B₂O₃ and less than approximately 3 wt.-% R₂₀ whereby the content of Al₂O₃ and B₂O₃ together is approximately 7 wt.-% to approximately 20 wt.-%. According to the invention, the glass material or glass ceramic material is characterised by the fact that transmission in the visible wavelength range between approximately 400 nm and approximately 800 nm based on a substrate thickness of approximately 20 mm, is at least approximately 65%, more preferably at least approximately 75% and even more preferably at least approximately 80%. Preferably, the glass material or glass ceramic material is provided by means of the apparatus according to the invention or the method according to the invention. Glass materials or glass ceramic materials with the above composition and with the aforementioned advantageously high transmission in the visible wavelength range are not currently known from prior art. These glass materials may be used, for example, as viewing glasses in furnaces or similar systems.

Preferably, the transmission in the range of a water absorption band at approximately 1350 nm, based on a substrate thickness of 20 mm, is at least approximately 75% and/or the transmission in the range of a water absorption band at approximately 2200 nm, based on a substrate thickness of 20 mm, is at least approximately 50%, more preferably at least approximately 55%. Such advantageously high optical transmission in the near infrared spectral range is not known from the prior art for glass materials of the aforementioned composition.

A further aspect of the invention relates to the use of the glass material according to the invention as a transitional glass material to connect two types of glass with different coefficients of thermal expansion, for example to establish a fused joint between silica glass and Duran glass that is difficult to achieve due to the large differences in the thermal expansion (α-value: silica glass 0.5×10⁻⁶ K⁻¹, Duran glass 3.3×10⁻⁶K⁻¹). Preferably, the expansion properties of the glass materials according to the invention are specially matched to each other and according to the invention they are fused together in stages of α=1.3×10⁻⁶⁻K⁻¹ through α=2.0×10⁻⁶⁻K⁻¹ to α=2.7×10⁻⁶⁻K⁻¹ with a tolerance of approximately 0.1×10⁻⁶K⁻¹.

### BRIEF DESCRIPTION OF DRAWINGS

The invention will now be further described with reference to preferred exemplary of embodiments shown in the drawings from which may be derived further features, advantages and problems to be resolved that are expressly the subject matter of this invention. Here:

FIG. 1 is a schematic cross section of an apparatus according to the prior art for the production of high-melting glass materials or glass ceramic materials;

FIG. 2 is a schematic partial section of a crucible with a tubular outlet in the apparatus according to FIG. 1;

FIG. 3 is a schematic cross section of an apparatus according to the present invention;

FIG. 4 shows in a perspective view a closure member for closing the tubular outlet in the apparatus according to FIG. 3;

FIGS. 5a and 5b show in a schematic cross section the front free end of the tubular outlet of an apparatus according to the present invention according to a further embodiment; and

FIG. 6 shows the spectral transmission of an example of a glass according to the present invention.

### DETAILED DESCRIPTION OF PREFERRED EMBODIMENTS

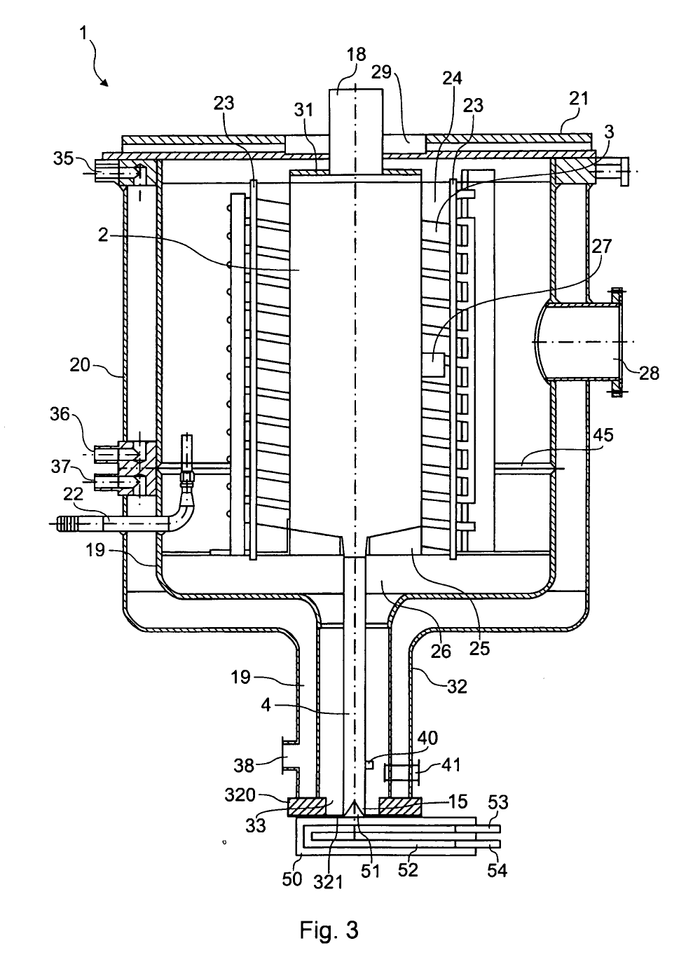

As shown in FIG. 3, overall, the upper part of the crucible 2 has a slim shape so that a heating device surrounding the crucible 2 results in the homogeneous heating of the molten glass accommodated in the crucible 2. An orifice ratio h/L of the cylindrical parts of the crucible 2 is preferably at least larger than approximately 2.0, more preferably larger than approximately 3.0 and even more preferably larger than approximately 4.0, whereby h is a maximum internal height of the cylindrical part of the crucible 2 and L is a maximum distance from the side walls or the diameter of the cylindrical part of the crucible 2.

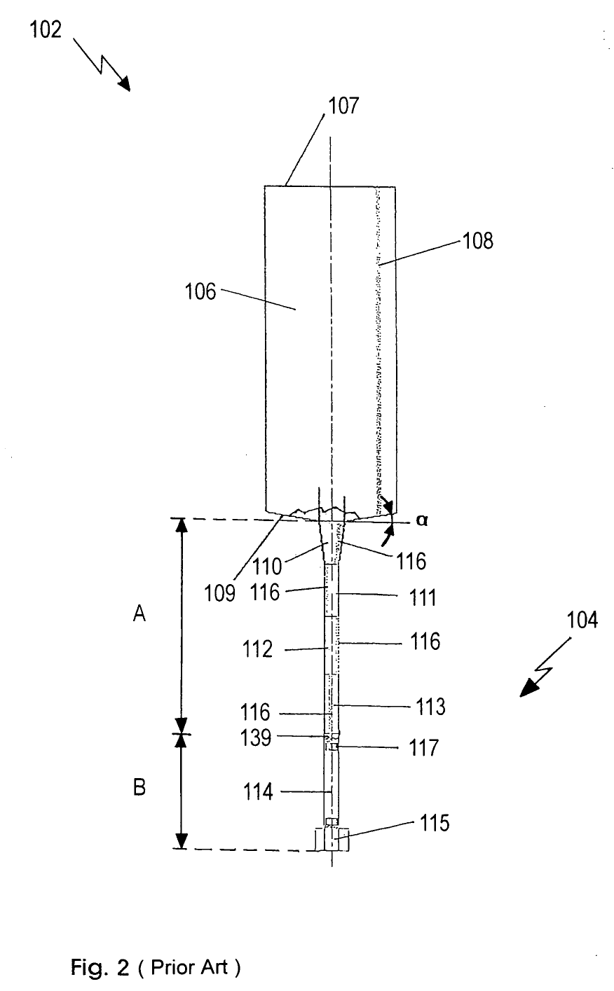

In a corresponding manner, as shown in FIG. 2, the base 9 is inclined radially inwardly about an angle alpha in the range of up to 2°, preferably in the range of approximately 10°, in order to encourage the running out of the molten glass. In principle, the base 9 may also have a cambered or flat shape.

According to a preferred embodiment, the crucible wall 6 of the crucible 2 is formed of a sheet of a length of 510 mm and a thickness of about 1.0 mm. The cylindrical part of crucible 2 thus has a nominal capacity of about 17 litres. For forming crucibles of a larger capacity the height of the cylindrical part can be increased or both the height and the diameter of the cylindrical part 6 can be increased in correspondence to the given opening ratio h/L. Herein it should be noted that the heating device (cf. FIG. 3) surrounding the cylindrical part 6 of crucible 2 is configured such that a homogeneous temperature profile can be accomplished via the diameter and height of the cylindrical part 6 of crucible 2.

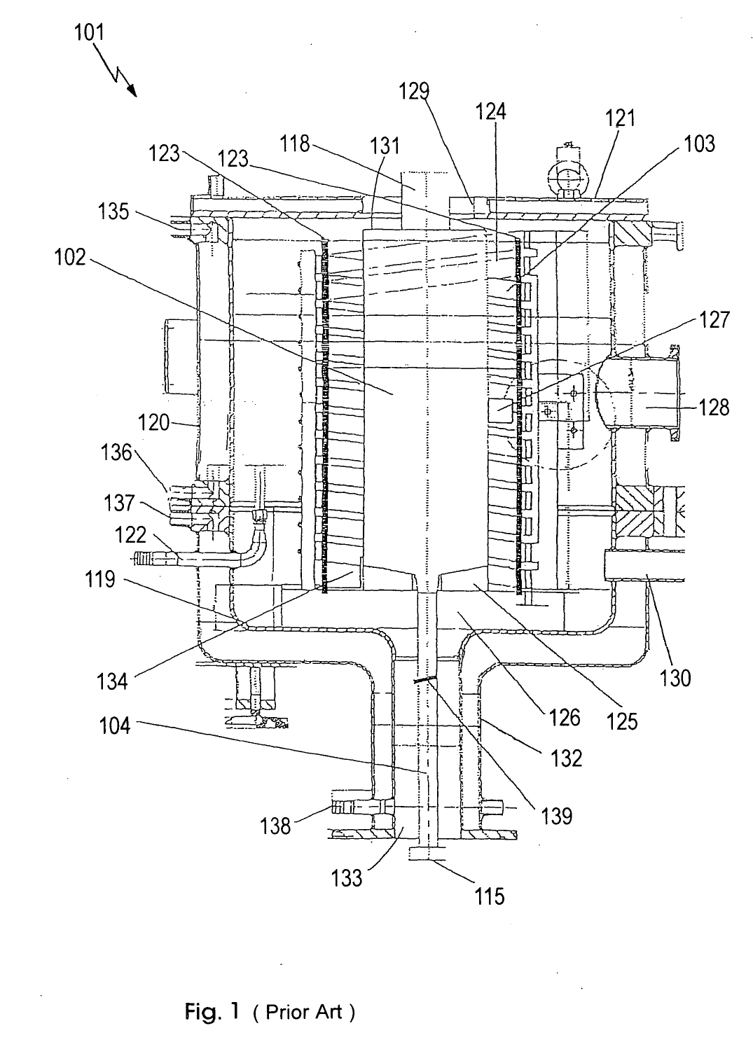

FIG. 3 schematically shows the configuration of an apparatus according to the present invention, which in principle has the same configuration as the conventional apparatus according to FIG. 1.

Different to FIG. 1 are in particular the following measures: the entire tubular outlet 4 of crucible 2 is formed of iridium or an iridium alloy having an iridium content of at least 50 wt.-%, as set forth above. Via the opening in the bottom of container 20 the front free end of the tubular outlet 4 protrudes into the lower container section 19. There, the front free end of tubular outlet 4 may be heated, in particular by resistive heating. The lower container section 19 is closed at its bottom end by a lid 320 which comprises a central bore, which passes over into the central opening 33 of container section 19. A sheet 321, which is welded to the front end of tubular outlet 4 or at least abuts the front end of tubular outlet 4, covers the central opening 33 of container section 19 so that only the front, relatively short section of the tubular outlet is in contact with ambient atmosphere. The upper container section 20 and the lower container section 19 are connected with each other in the area of connecting flange 45. The upper and lower container section 20 and 19, respectively, can be cooled separately from each other via the coolant ports 35, 36 and 37, 38, respectively. In the upper container section 20, between the side wall of crucible 2 and cylinder 23 of the refractory material a layer of plates of MgO is disposed instead of the pellet filling shown in FIG. 1. In extension of feed through 28 a sleeve 27 for accommodating a temperature sensor is formed in the MgO plates. A feed through 41 for the wires of a temperature sensor and of the lug of a thermocouple 40 is also formed in the lower container section 19 near the orifice of tubular outlet 4.

The upper rim 7 of crucible 2 is flat-shaped. A lid 31 is put onto the upper rim 7, as shown in FIG. 3, which serves to ensure a thermal insulation of the molten glass accommodated in crucible 2 as well as a further protection of the molten glass against the ambient atmosphere. The lid 31 can be put onto the upper rim 7. The lid 31 can also be put onto upper rim 7 and connected therewith, so that the crucible 2 is closed in a gas-tight manner to a certain extent so that an atmosphere with a certain over-pressure can be built-up in the crucible 2 by inflowing gas, preferably protective gas, via a gas inlet not shown into the interior of crucible 2 above the level of the molten glass. This over-pressure can be used e.g. for compensating the hydrostatic pressure of the molten glass which is reduced due to the discharge of molten glass out of tubular outlet 4.

The crucible wall 6 and the tubular outlet 4 are made of iridium with an iridium content of at least approximately 99%, more preferably at least 99.5% and even more preferably at least approximately 99.8% so that their melting point is approximately 2,400° C. Quite particularly preferred is an iridium with an iridium content of at least approximately 99.8% and a content of elements from the platinum group of at least 99.95%. Here, the maximum content of Pt, Rh and W is approximately 1,000 ppm each, the maximum content of Fe approximately 500 ppm, the maximum content of Ru approximately 300 ppm, the content of Ni approximately 200 ppm, the maximum content of Mo, Pd approximately 100 ppm each, the maximum content of Cu, Mg, Os, Ti approximately 30 ppm each and the maximum content of Ag, Al, As, Au, B, Bi, Cd, Cr, Mn, Pb, Si, Sb, V, Zn, Zr approximately 10 ppm each.

Other possible materials for the crucible wall 6 and tubular outlet 4 may in principle be iridium alloys out of an alloy from the platinum group, with an iridium content of at least approximately 95%, more preferably at least approximately 96.5% and even more preferably at least approximately 98%. When processing the aforementioned materials, it should be noted that they are relatively brittle and only become ductile at comparatively high temperatures.

In a preferred exemplary embodiment, the induction coil 3 is driven by a converter with a connected load of approximately 50 kW at a frequency of approximately 10 kHz. This enables temperatures of above 2,000° C. to be achieved in the cylindrical section of the crucible 2 even in long-term operation.

The first base element 25 supporting the crucible 2, the refractory cylinder 23 and the induction coil 3 rest on a second base element 26 which is supported on the base of the lower container section 19. The second base element 26 provides a mechanical support for this arrangement and sufficient thermal insulation. The thickness of the second base element 26 is selected appropriately for this end. The material used for the second base element 26 must be sufficiently thermally and dimensionally stable and oxidation-resistant. In a preferred exemplary embodiment, the second base element 26 comprises ZrSiO₄. The base element 26 can also split into two parts and be substituted by an upper base element of ZrSiO₄ and a lower base element of a standard refractory material (e.g. L300).

The first base element 25 and the second base element 26 have an orifice through which the outlet tube 4 reaches the lower container section 19. Via the central orifice in the base sheet 321 the front end of tubular outlet 4 is finally exposed to ambient atmosphere. The lower cylindrical section of the lower container section 19 surrounds the outlet tube 4. Apart from a small section (the segment given the reference number 15) of the lower tube section, the outlet tube 4 comprising oxidation-resistant noble metal is located in the lower container section and is closed in a gas-tight manner by the lid 320 acting as a closure member, to prevent the penetration of atmospheric air into the lower container section 19.

According to the present invention it is preferred if a short section of outlet tube 4 is exposed to ambient atmosphere. Thus, the position of the transition area shown in FIG. 3 shall only serve for illustrative purposes and shall not be interpreted true to scale.

As FIG. 3 shows, there is a gas inlet 22 in the lower container section 19 that serves to supply a protective gas into the interior of the container. The gas inlet 22 is connected to a gas line, not shown, and a gas reservoir, not shown. Overall, therefore, the container is flushed by a protective gas and the protective gas flows round the crucible 2 accommodated in the container in order effectively to prevent oxide formation of the iridium or the iridium alloy with an iridium content of at least 50 wt.-% of the crucible 2 and of the first section of the outlet tube 4.

The protective gas maintains neutral to slightly oxidising conditions in the interior of the container. To this end, a protective gas with an oxygen content of between approximately 5×10⁻³% and approximately 5% and more preferably between approximately 0.5% and approximately 2% may be used. Overall, the protective gas used is low-reactive and only reacts with the iridium or the iridium alloy with an iridium content at least 50 wt.-% to a negligible extent. Particularly suitable as inert, low-reactive protective gases are argon or nitrogen. The aforementioned small additions of oxygen are able to suppress reactions between the material of the crucible and glass components (reduction of glass components with subsequent alloy formation). In addition, the interior of the crucible is flushed with protective gas to protect the internal wall of the crucible against oxidation caused by atmospheric oxygen.

According to a further preferred embodiment the outside between crucible 2 and container 19/20 is held under a neutral or slightly reducing protective gas atmosphere, because here no molten glass exists having constituents that can be reduced. Then, a neutral or slightly oxidizing protective gas atmosphere may be applied to the interior of crucible 2 via a gas feed-through through lid 18 and 31, respectively, as described above. To this end it is an advantage that contrary to platinum iridium permeable for gases.

The container does not have to be pressure-tight since it is sufficient for an equilibrium of flow to form in the interior of the container that guarantees a sufficient protective gas atmosphere therein. In principle, however, the container 5 may have a pressure-tight design in order more efficiently to prevent the penetration of oxygen from the ambient atmosphere into the interior of the container.

According to the invention, the use of iridium or an alloy with an iridium content of at least 50 wt.-% for the crucible permits melting temperatures of approximately 2,000° C. or above. This considerably accelerates all the physical and chemical aspects of the melting process. The processing times are significantly reduced in conjunction with a simultaneous increase in quality. Consequently, the invention may be used to produce glass materials or glass ceramic materials with new surprisingly advantageous properties.

Quite generally, the apparatus according to the invention is operated in two different operating modes. Firstly, by opening the lid 18 enables a quantity of glass material or a corresponding raw material to be successively introduced into the crucible 2. During this phase of melting at low temperatures, the temperature of the crucible 2 may also be selected correspondingly low, preferably, however, the temperature of the crucible 2 is kept above approximately 1,800° C. even during the phase of melting at low temperatures.

For the further treatment of the molten glass, in particular for the fining, the temperature of the crucible 2 is maintained by means of the induction coil 3 way above the later processing temperature of the molten glass. The very high temperatures possible according to the invention mean the fining processes can take place much more effectively. In this first operating mode, the temperature of the outlet tube 4 is kept comparatively low and below the melting temperature of molten glass. Care should be taken that with the exception of casting or pouring out of the molten glass out of the outlet tube the front free end of outlet tube, which is exposed to ambient atmosphere, is held at a temperature below 1,000° C., more preferably below 950° C. As a result, a stopper or plug comprising viscous or solidified molten glass forms in the outlet tube 4 and this prevents the molten glass from running out of the crucible 2 and prevents an oxidative decomposition of the inner surface of outlet tube 4. During the fining process, conventional fining agents in the molten glass are activated. A stirring device, not shown, may be disposed in the crucible 2 or inserted therein through the cover 31 to stir the molten glass in the crucible 2. According to the invention, the stirring device is made of the aforementioned iridium or of the aforementioned iridium alloy with an iridium content of at least 50 wt.-%. According to the invention, the actual stirring device may also be used to blow in gases, for example reducing gases.

The transitional area between the liquid molten glass and the highly viscous or solidified stopper is not fixed, but is preferably located inside the outlet tube 4. This means a very homogeneous molten glass is established inside the crucible 2.

During the first operating mode, the outlet tube 4 does not necessarily have to be heated because a suitable layout of the lower cylindrical section of the lower container section 19 can ensure suitable cooling of the outlet tube 4 by means of heat radiation. In principle, however, the outlet tube 4 may also be subject to controlled or regulated heating or cooling during the first operating mode.

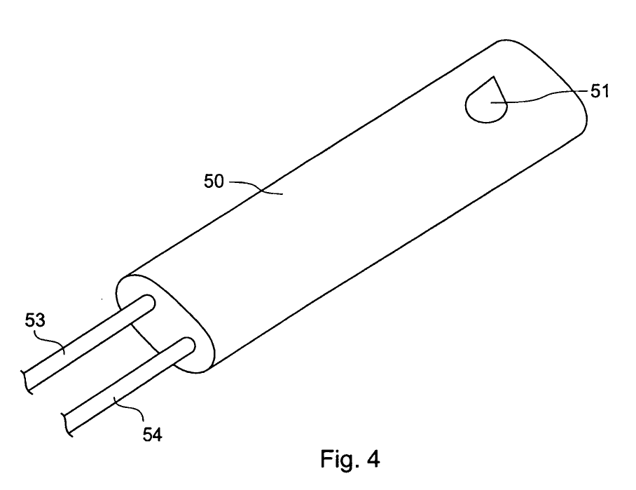

As shown in FIG. 3, the orifice of outlet tube 4 is closed by a copper plate 50 acting as a closure member, on the upper side of which there is formed a tapered mandrel 51 which extends into the orifice and closes the orifice by establishing a tight contact with the inner surface of outlet tube 4. As an alternative, the upper side of the copper plate 50 acting as a closure member may also be shaped flat. FIG. 4 shows such a closure member 50 in a perspective view. As schematically shown in FIG. 3, a cooling channel 52 is drilled or milled into the closure member. As feed lines two copper tubes 53, 54 are soldered into the bore. Water or any other suitable coolant, also air, an air-water-aerosol, oil or the like may flow through the closure member. The closure member 50 is positioned with its wider surface below outlet tube 4 of the crucible after being connected with a suitable cooling system. In an exemplary embodiment the dimensions of the closure member 50 were 100 mm×40 mm×20 mm and copper tubes of an inner diameter of 13 mm, an outer diameter of 15 mm and a length of 350 mm were used as a feed line for the coolant. By means of the full-surface contact between the mandrel 51 and the flat upper surface of closure member 50 with the front free end of outlet tube 4 a sufficient thermal contact can be ensured in order to sufficiently cool the front free end of outlet tube 4 which is exposed to ambient atmosphere. Expediently, the front free end of outlet tube 4 can be held at a temperature below 1,000° C., more preferably below 950° C., during the afore-mentioned stage of fining the molten glass.

Following fining, when molten glass of a suitable quality has established itself in the crucible 2, the temperature of the molten glass in the crucible 2 may be reduced to the processing temperature to adopt a second operating mode and the outlet tube 4 is heated to the processing temperature. The processing temperature is selected so that the molten glass has a desired viscosity or is suitable for the production of formed parts. The processing temperature is higher than the melting point of the molten glass and can be altered by changing the heat output from the induction coil 3 and the heating current heat output on the outlet tube 4. The crucible 2 and the outlet tube 4 can also be held at different temperatures, for example with a temperature difference of approximately 10 to 40° C.

In the second operating mode, the stopper or plug in the outlet tube 4 melts or softens so that the molten glass runs out of the outlet tube 4. Here, the molten glass is formed by the profile of the outlet tube 4 and/or by further heat forming devices, for example a draw die, as indicated in FIG. 3 with reference number 15. According to the invention, both solid members, for example rods, and hollow members, for example tubes, may be produced.

Instead of glass formed parts, the emergent molten glass may also be quenched and hence further processed to produce a powder.

According to a further embodiment also a different type of glass as the type accommodated in the crucible 2 may be used for the formation of the stopper or plug in the outlet tube 4, with a softening temperature below 1,000° C., more preferably below 950° C. To this end, any non-oxidizing gas is preferably used. In order to prevent a mixing between the content of the outlet tube and of the crucible, the closure member is strongly cooled such that the temperature in the outlet tube is held at least 100° C. below that of the crucible. However, in this embodiment the first portion of the casting, which consists of the different type of glass, must be discarded.

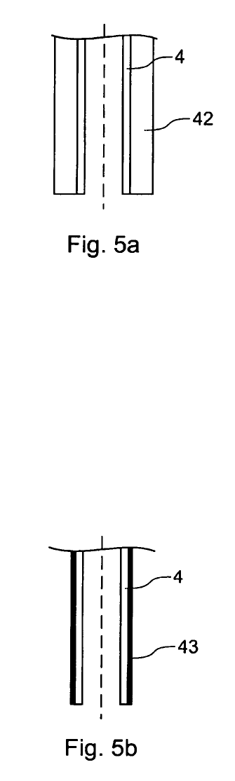

In the following, with reference to FIGS. 5a and 5b further measures for protecting the outer surface of the front free end of outlet tube 4, which is exposed to ambient atmosphere, are described. According to FIG. 5a a cylindrical or annular perforated or porous member 42 is disposed around the outlet tube 4, via which a protective gas is directed over the outer surface of the front free end of outlet tube 4. The member 42 preferably encloses the outlet tube while contacting the same. The heating device, e.g. an induction coil, for heating the outlet tube 4 is preferably disposed on the outer circumference or outside of member 42. The member 42 preferably fills the entire cylindrical, hollow part of the lower container section (cf. 3), which is exposed to ambient atmosphere. In order to establish a better heat conduction between the heating device (not shown) and outlet tube 4 the member 42 is preferably made of a metal, in particular of a perforated metal cylinder, a hollow, cylindrical sintered body of a metal or a hollow, cylindrical metal foam. N2 or the well-known noble gases or mixtures of the afore-mentioned gases with H2 are suitable protective gases.

Temporarily, the member 42 may additionally be cooled. This can be accomplished by feeding a strongly cooled protective gas in the gas or liquid phase. Of course, additional cooling means may be provided at or within the member 42, in particular a cooling channel through which a coolant may flow.

FIG. 5b shows another exemplary embodiment, wherein the outer surface of the front free end of outlet tube 4, which is exposed to ambient atmosphere, is covered with a gas-tight and thin layer of a refractory ceramic material, which is coated onto the outer surface in particular using plasma spraying. As regards details of the outer coating 43, reference is made to WO 02/44 115 A2 or corresponding US 2004/0067369 A1 of the applicant or to EP 1 722 008 A2 of the applicant, the whole content of which is hereby incorporated by reference.

Of course, also the outer surface of crucible 2 may be covered by a refractory ceramic material in its entirety or in sections in a corresponding manner, which is applied in particular using plasma spraying.

The apparatus according to the invention may, in principle, be used to produce all known types of glass material. However, the apparatus according to the invention is particularly preferred for glass materials or glass ceramic materials comprising only a very low content of network modifiers, in particular alkali oxides, or for glass materials or glass ceramic materials comprising a high content of high-melting oxides, such as, for example, SiO₂, Al₂O₃, Nb₂O₅ or Ta₂O₅. According to the invention, the glass material or the glass ceramic material have an SiO₂ content of approximately 80 wt.-% to approximately 90 wt.-%, an Al₂O₃ content of approximately 0 wt.-% to approximately 10 wt.-%, a B₂O₃ content of approximately 0 wt.-% to approximately 15 wt.-% and an R₂ O content of less than approximately 3 wt.-%, whereby the content of Al₂O₃ and B₂O₃ together is approximately 7 wt.-% to approximately 20 wt.-% and R stands for an alkali element of a group comprising Li, Na, K, Rb and Cs. Glass materials with the aforementioned composition could not be produced using crucibles known from the prior art, or at least not with a satisfying quality. In the afore-mentioned glass materials up to the half (50%) of the SiO₂ may be substituted by GeO₂ and/or P₂O₅. In the case of an admixture of P₂O₅ AlPO₄ forms in the absence of Al₂O₃, which behave like SiO₂.

Expediently, the glass composition can also comprise still further high-melting oxides for example, up to approximately 20 wt.-% MgO and/or up to approximately 10 wt.-%, more preferably up to approximately 5 wt.-% of TiO₂, ZrO₂, Nb₂O₅, Ta₂O₅, WO₃ or MoO₃ or mixtures thereof. Further optional constituents may be CaO, SrO and BaO.

A preferred usage according to the invention relates to the production of so-called transitional glass materials that serve to produce a fused joint between a glass material with a low coefficient of thermal expansion and a glass material with a high coefficient of thermal expansion, for example between silica glass with a coefficient of thermal expansion of 0.5×10⁻⁶ K⁻¹ and Duran glass with a coefficient of thermal expansion of approximately 3.3×10⁻⁶ K⁻¹. According to the invention, transitional glass materials may be produced with coefficients of thermal expansion that have been specially adapted to the two types of glass to be joined, as described below.

Further glass materials that can be produced are coating or evaporation glasses and display glass, which are also free of alkali oxides.

With regard to further details of the composition and characteristics of the glass materials or glass ceramic materials according to the present invention, reference is made to DE 103 48 466 A1 or corresponding US 2005/0109062 A1 of the applicant, which are incorporated by reference.

Table 1 summarises the composition and the coefficients of thermal expansion determined for different transitional glass materials produced in accordance with the invention and the following example of an embodiment.

TABLE 1

| Oxides in | | | | | |
|---|---|---|---|---|---|
| (weight-%) | 8228 | 8229 | 8230 | New 1 | New 2 |
| SiO₂ | 82.1 | 87.0 | 83.6 | 83.0 | 82.5 |
| B₂O₃ | 12.3 | 11.6 | 11.0 | 12.5 | 8.6 |
| Al₂O₃ | 5.3 | — | 2.5 | 4.5 | 5.5 |
| Na₂O | — | 1.4 | 2.2 | — | — |
| K₂O | — | — | 0.3 | | |
| Fining agent | 0.05-0.2 | 0.05-0.2 | 0.05-0.2 | 0.05-0.2 | 0.05-0.2 |
| α(×10⁻⁶) | 1.3 | 2.0 | 2.7 | 1.15 | 1.0 |

The transitional glass materials with the type designations 8228, 8229 and 8230 of Schott have coefficients of thermal expansion of 1.3×10⁻⁶ K⁻¹, 2.0×10⁻⁶ K⁻¹ and 2.7×10⁻⁶ K⁻¹ respectively and are therefore excellently suited for the production of a fused joint between silica glass and Duran glass. All the glass material types listed in Table 1 have a refractive index of less than approximately 1.47. The types of glass material in columns 4 and 5 cannot be produced with conventional, non-iridium-containing crucibles according to the prior art.

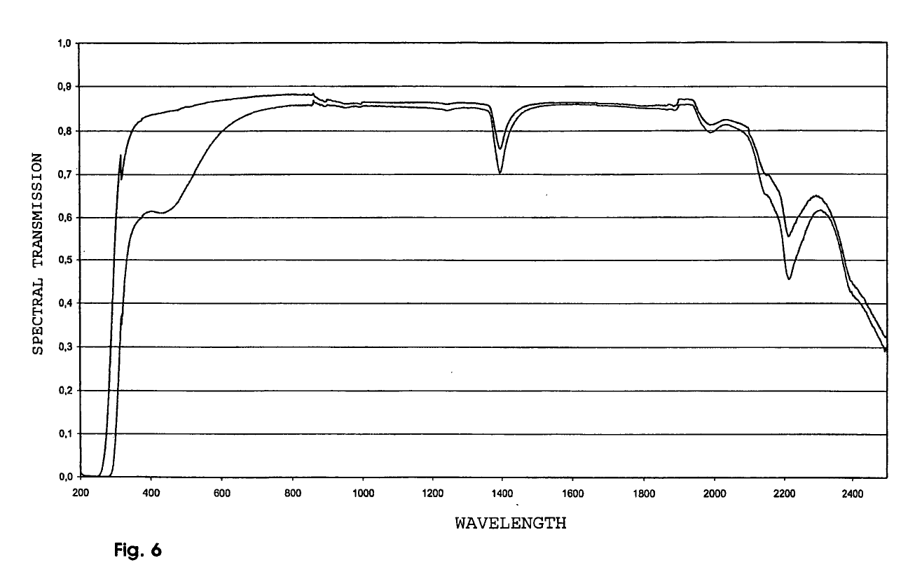

Due to the much higher temperatures made possible by the invention, it is possible to produce new types of glass materials and glass ceramic materials with the aforementioned composition with previously unattainable properties. An example of this may be found in FIG. 6, which shows the spectral transmission of the type of glass material designated 8228 in Table 1. FIG. 6 shows the spectral transmission of a type of glass 8228 which was produced with a apparatus according to the invention and in accordance with the example of an embodiment 1 described in detail below, compared with a conventional, non-iridium-containing crucible in accordance with the prior art at temperatures of 1760° C. In FIG. 6, the upper curve represents the spectral transmission of a type of glass material designated 8228 produced according to the invention in accordance with the following example of an embodiment 1 and the lower curve represents the spectral transmission of a type of glass material designated 8228 according to the prior art.

In addition to the use of high-melting raw materials, the high melting temperatures also permit the use of non-toxic high-temperature fining agents such as, for example SnO₂ instead of As₂O₃. Therefore, the amount of fining agent required is corresponding less than that determined for the PtRh30 crucible. Glass compositions that cannot be melted or are very expensive to melt due to their high viscosity may be produced economically in the iridium crucible. In addition to the high temperatures, iridium has the advantage over the PtRh30 alloy that it causes less colour cast (Rh) in the glass material. This means it is possible to produce products meeting optical requirements. This is demonstrated in FIG. 6. The better transmission in the visible range of the sample melted in the Ir crucible is clearly evident. Here, visually there is a slightly yellow colour effect, while a clear reddish-brown colour cast occurs when PtRh30 is used. The water bands were less intensively formed in the IR spectral range; this was a result of the much higher melting temperature.

The following lists some other types of glass materials that may be melted with the apparatus according to the invention.

Cordierite-like glass ceramic materials comprising SiO₂ in the range between 40 wt.-% and 60 wt.-%, Al₂O₃ in the range between 25 wt.-% and 45 wt.-% and MgO in the range from 10 wt.-%-20 wt.-%. Expediently, the glass composition may also comprise up to approximately 10 wt.-%, preferably up to approximately 5 wt.-%, further high-melting oxides for example TiO₂, ZrO₂, Nb₂O₅, Ta₂O₅ or WO₃ or mixtures thereof. In principle, MoO₃ is also possible, but its use could result in the discoloration of the glass depending on the application.

As is evident to a person skilled in the art from the above description, the invention includes numerous other aspects that may in principle also be claimed separately by means of independent claims.

The aforementioned method may, in principle, be use to produce glass ceramic materials with any compositions. Preferably, glass ceramic materials are produced with compositions as disclosed in the following patents or patent applications and the content of their disclosures is expressly included in this patent application by reference: EP 0 220 333 B1 corresponding to U.S. Pat. No. 5,212,122, DE 43 21 373 C2 corresponding to U.S. Pat. No. 5,446,008, DE 196 22 522 C1 corresponding to U.S. Pat. No. 5,922,271, DE 199 07 038 A1, DE 199 39 787 A1 corresponding to WO 02/16279, DE 100 17 701 C2 corresponding to U.S. Ser. No. 09/829,409 corresponding to U.S. Pat. No. 6,846,760, DE 100 17 699 A1 corresponding to U.S. Pat. No. 6,594,958 and EP 1 170 264 A1 corresponding to U.S. Pat. No. 6,515,263.

As will become apparent to a person skilled in the art when studying the present application, many variations and modifications of the subject-matter of this application can be performed without leaving the spirit of the invention and the scope of the appended claims. Any of such variations and modifications within the scope of the present invention and of the appended claims are therefore intended to be covered by the present application.

What is claimed is:

1. A method for the production of high-melting glass materials, glass ceramic materials or ceramic materials, by a process during which a temperature of a molten mass exceeds 1,760° C., comprising the steps of:
melting of a shard material or raw material to a molten mass;
fining the molten mass; and
pouring the molten mass out via a tubular outlet of iridium or an iridium alloy having an iridium content of at least 50 wt.-%, wherein
the temperature of a section of said tubular outlet, which is in contact with the ambient atmosphere having a natural gas composition, is controlled or regulated such that said temperature is held below 1,000° C. except during pouring out the molten mass out of said tubular outlet.

2. The method as claimed in claim 1, wherein the temperature of said section of said tubular outlet, which is in contact with the ambient atmosphere, is controlled or regulated such that said temperature is held below 950° C. except during pouring out the molten mass out of said tubular outlet.

3. The method as claimed in claim 1, wherein the shard material or raw material having a first predetermined composition is placed into a vessel for accommodating said molten mass, said vessel comprising said tubular outlet, wherein
the vessel is made of iridium or an iridium alloy having an iridium content of at least 50 wt.-%;
said vessel is disposed within a container; and
a protective gas atmosphere is provided within said container such that said vessel and a section of said tubular outlet are accommodated within said container under said protective gas atmosphere for preventing oxide formation of said iridium or said iridium alloy; in which method
said step of placing the shard material or raw material having the first predetermined composition comprises the steps of:
blocking an orifice of said tubular outlet;
placing a shard material or raw material having a second predetermined composition into said tubular outlet; and
heating said tubular outlet above a softening temperature of said shard material or raw material having the second composition and cooling said tubular outlet for forming a stopper of molten, gas-tight glass, which plugs said tubular outlet.

4. The method as claimed in claim 3, wherein the steps of heating said tubular outlet above the softening temperature of said shard material or raw material having the second composition and of cooling the tubular outlet for forming said stopper are repeated until the entire tubular outlet is filled.

5. The method as claimed in claim 3, wherein said vessel is not heated for formation of said stopper within said tubular outlet.

6. The method as claimed in claim 3, wherein the first and second compositions are identical and each have a softening temperature below 1,000° C., more preferably below 950° C.

7. The method as claimed in claim 3, wherein the softening temperature of the shard material or raw material of the first composition is above 1,000° C., the first and second compositions are different and the shard material or raw material of the second composition are shards of a non-oxidizing glass.

8. The method as claimed in claim 7, wherein the shard material or raw material having the second composition is free of Fe₂O₃, As₂O₃, Sb₂O₃ and/or As₂O₅.

9. The method as claimed in claim 3, wherein said vessel is heated during said step of heating the tubular outlet above the softening temperature of the shard material or raw material having the second composition and during cooling the tubular outlet for forming said stopper, wherein the temperature in said tubular outlet is held at least 100° C. below the temperature in said vessel.

10. The method as claimed in claim 1, wherein heat is actively dissipated from said section of said tubular outlet, which is in contact to the ambient atmosphere, except during pouring out said molten mass out of said tubular outlet.

11. The method as claimed in claim 10, wherein heat is dissipated from said section of said tubular outlet, which is in contact to the ambient atmosphere using a closure member, which blocks said orifice of said tubular outlet.

12. The method as claimed in claim 11, wherein a coolant flows through said closure member.

13. The method as claimed in claim 1, wherein an outer surface of said section of said tubular outlet, which is contact to the ambient atmosphere, is protected by an inert protective gas while said molten glass is poured out of said tubular outlet.

14. The method as claimed in claim 13, wherein said inert protective gas is directed over the outer surface of said section of said tubular outlet, which is in contact with the ambient atmosphere, by means of a perforated or porous cylindrical or annular member.

15. The method as claimed in claim 14, wherein said perforated or porous cylindrical or annular member is cooled.

16. The method as claimed in claim 14, wherein said protective gas comprises N₂ and/or a noble gas.

17. The method as claimed in claim 16, wherein said protective gas further comprises H₂.

18. The method as claimed in claim 1, wherein said vessel is provided such that an outer surface of said section of said tubular outlet, which is in contact with the ambient atmosphere, is covered by a gas-tight, thin layer of a refractory ceramic material.

19. The method as claimed in claim 18, wherein the outer surface of said section of said tubular outlet, which is in contact with the ambient atmosphere, is applied by plasma spraying.

20. The method as claimed in claim 1, wherein in a first operating mode the molten mass in said vessel is initially held at a temperature far above a processing temperature of said molten mass for fining while said tubular outlet is held at a temperature at which the molten mass forms a stopper which blocks said outlet; and
in a second operating mode the temperature of said molten mass in said vessel is lowered to the processing temperature after fining, while said tubular outlet is heated to said processing temperature so that the stopper is resolved and the molten mass pours out of said tubular outlet.

21. The method as claimed in claim 20, wherein the temperature during the first operating mode is at least 1,800° C., more preferably at least 2,000° C. and even more preferably at least 2,200° C.

22. The method as claimed in claim 1, wherein the glass composition comprises 80 wt.-% to 90 wt.-% SiO₂, 0 wt.-% to 10 wt.-% Al₂O₃, 0 wt.-% to 15 wt.-% B₂O₃ and less than 3 wt.-% R₂O, wherein the content of Al₂O₃ and B₂O₃ together is 7 wt.-% to 20 wt.-% and R stands for an alkali element of a group comprising Li, Na, K, Rb and Cs.

23. The method as claimed in claim 22, wherein up to 50 wt.-% of SiO₂ is substituted by GeO₂ and/or P₂O₅, wherein the glass composition preferably contains a non-vanishing portion of Al₂O₃ if P₂O₅ is applied.

24. The method as claimed in claim 22, wherein the glass composition further comprises high-melting oxides of up to 20 wt.-% MgO and/or up to 10 wt.-%, more preferably up to 5 wt.-% of TiO₂, ZrO₂, Nb₂O₅, Ta₂O₅, WO₃ or MoO₃ or mixtures thereof.

25. The method as claimed in claim 24, wherein the glass composition further comprises the oxides CaO, SrO and/or BaO and further comprises MgO.

26. The method as claimed in claim 25, wherein the glass is display glass.

27. The method as claimed in claim 20, wherein the temperature during the first operating mode is at least 1800° C., more preferably 1850° C. and wherein the glass composition comprises 40 wt.-% to 60 wt.-% SiO₂, 25 wt.-% to 45 wt.-% Al₂O₃ and 10 wt.-% to 20 wt.-% MgO.

28. The method as claimed in claim 1, wherein the molten mass is shaped into a formed member on its emergence from the tubular outlet or of a heat forming device provided on the tubular outlet.

29. The method as claimed in claim 22, wherein the molten mass is molten and fined such that a transmission of said glass or glass ceramic material in the visible wavelength range between 400 nm and 800 nm, based on a substrate thickness of 20 mm, is at least 65%, more preferably at least 75% and even more preferably at least 80%.

30. The method as claimed in claim 20, wherein the glass composition comprises 80 wt.-% to 90 wt.-% SiO₂, 0 wt.-% to 10 wt.-% Al₂O₃, 0 wt.-% to 15 wt.-% B₂O₃ and less than 3 wt.-% R₂O, wherein the content of Al₂O₃ and B₂O₃ together is 7 wt.-% to 20 wt.-% and R stands for an alkali element of a group comprising Li, Na, K, Rb and Cs and wherein the molten mass is molten and fined during the first operating mode such that a transmission of said glass or glass ceramic material in the wavelength range of a water absorption band at 1,350 nm, based on a substrate thickness of 20 mm, is at least 75% and/or the transmission in the wavelength range of a water absorption band at 2,200 nm, based on a substrate thickness of 20 nm, is at least 50% and more preferably at least 55%.

31. An apparatus for the production of high-melting glass materials, glass ceramic materials or ceramic materials, by a process during which a temperature of a molten mass exceeds 1,760° C., said apparatus at least comprising:
a vessel for melting a shard material or raw material to a molten mass and for fining the molten mass; and
a tubular outlet of iridium or an iridium alloy having an iridium content of at least 50 wt.-% for pouring out said molten mass in a discontinuous process; and
means for controlling or regulating the temperature of a section of said tubular outlet, which is in contact with the ambient atmosphere having a natural gas composition, such that said temperature is held below 1,000° C. except during pouring out the molten mass out of said tubular outlet.

32. The apparatus as claimed in claim 31, wherein the means for controlling or regulating controls or regulates a heating device such that the temperature of said section of said tubular outlet, which is in contact with the ambient atmosphere, is held below 950° C. except during pouring out the molten mass out of said tubular outlet.

33. The apparatus as claimed in claim 31, further comprising a movable closure means for blocking an orifice of said tubular outlet for optionally opening or blocking said orifice.

34. The apparatus as claimed in claim 33, wherein a coolant can flow through said closure means for actively dissipating heat from said section of said tubular outlet, which is in contact with the ambient atmosphere.

35. The apparatus as claimed in claim 34, wherein said means for controlling or regulating further controls or regulates a flow rate of said coolant through said closure means more particularly reduces or blocks a flow of said coolant through said closure means while said molten mass is poured out of said tubular outlet.

36. The apparatus as claimed in claim 33, wherein said closure means comprises a tapered protrusion for closing the orifice of said tubular outlet.

37. The apparatus as claimed in claim 31, wherein a first heating device and a second heating device are associated with said vessel and said tubular outlet, respectively, so that said vessel and said tubular outlet can be heated separately.

38. The apparatus as claimed in claim 37, wherein said means for controlling or regulating controls or regulates the first and second heating device such that the temperature in said tubular outlet is held at least 100° C. below the temperature in said vessel.

39. The apparatus as claimed in claim 37, wherein said means for controlling or regulating further controls or regulates a flow rate of said coolant through said closure means more particularly reduces or blocks a flow of said coolant through said closure means while said molten mass is poured out of said tubular outlet and wherein said means for controlling or regulating controls or regulates the first and second heating device and the flow rate of the coolant through said closure means such that the temperature in said tubular outlet is held at least 100° C. below the temperature in said vessel.

40. The apparatus as claimed in claim 31, further comprising a perforated or porous cylindrical or annular member that is disposed around said section of said tubular outlet, which is in contact with the ambient atmosphere, and/or is configured for directing an inert protective gas over an outer surface of said section of said tubular outlet, which is in contact with the ambient atmosphere.

41. The apparatus as claimed in claim 40, wherein said perforated or porous cylindrical or annular member can be cooled.

42. The apparatus as claimed in claim 40, wherein said perforated or porous cylindrical or annular member is connected with a reservoir of a protective gas, which is fed to said member, wherein said protective gas comprises N₂ and/or a noble gas.

43. The apparatus as claimed in claim 31, wherein an outer surface of said section of said tubular outlet, which is in contact with the ambient atmosphere, is covered by a gas-tight, thin layer of a refractory ceramic material.

44. The apparatus as claimed in claim 43, wherein the outer surface of said section of said tubular outlet, which is in contact with the ambient atmosphere, is coated with said layer by plasma spraying.

45. The apparatus as claimed in claim 31, wherein said means for controlling or regulating controls or regulates a heating device and/or the temperature of said closure member such that
in a first operating mode the molten mass in said vessel is initially held at a temperature far above a processing temperature of said molten mass for fining while said tubular outlet is held at a temperature at which the molten mass forms a stopper which blocks said outlet; and
in a second operating mode the temperature of said molten mass in said vessel is lowered to the processing temperature after fining, while said tubular outlet is heated to said processing temperature so that the stopper is resolved and the molten mass pours out of said tubular outlet.

46. The apparatus as claimed in claim 45, wherein said means for controlling or regulating is configured such that the temperature during the first operating mode is at least 1,800° C., more preferably at least 2,000° C. and even more preferably at least 2,200° C.

47. The apparatus as claimed in claim 31, further comprising a hot forming device provided at or on the tubular outlet for forming the molten mass when it emerges out or said orifice of said tubular outlet.

48. The apparatus as claimed in claim 31, wherein said vessel and a lid for covering said lid are pressure-tight.

49. The apparatus as claimed in claim 48, wherein said vessel comprises a gas inlet for feeding an inert gas to the interior of said vessel, wherein a controlling or regulating device for controlling or regulating a pressure of said inert gas in said interior is provided.
